(19) United States
(12) Patent Application Publication
(10) Pub. No.: US 2022/0285972 A1
(43) Pub. Date: Sep. 8, 2022

(54) System and Method for Battery Recharging

(71) Applicant: Jesse Thomas, Anderson, IN (US)

(72) Inventor: Jesse Thomas, Anderson, IN (US)

(21) Appl. No.: 17/678,021

(22) Filed: Feb. 23, 2022

Related U.S. Application Data
(60) Provisional application No. 63/157,764, filed on Mar. 7, 2021.

(51) Int. Cl. H02J 7/34; H02J 7/00

(52) U.S. Cl. CPC H02J 7/342; H02J 7/0013; H02J 7/0048; H02J 7/00712; H01H 21/54

(57) ABSTRACT

A battery recharging system is disclosed that comprises at least a first battery, a second battery, a switch, a charger and an output port. Switch is configured to be activated in one of a first configuration or a second configuration and connected to a first positive terminal of the first battery, a second positive terminal of the second battery, inverter, charger unit, and output port. Activation is based on charging level of at least one of the first battery and the second battery. Inverter includes inverter input terminal connected to one of the first positive terminal or the second positive terminal via the switch. Charger unit includes charger input terminal connected to the inverter output terminal of the inverter. The charger output terminal is connected to one of the first positive terminal or the second positive terminal via the switch. The output port is connected to the charger output terminal.

### CROSS-REFERENCE TO RELATED APPLICATIONS

This patent application claims priority to, and the benefit from U.S. Provisional Utility Application Ser. No. 63/157,764, filed on Mar. 7, 2021.

### FIELD OF TECHNOLOGY

The present invention relates to electric powering systems, and more specifically, to a system and method for battery recharging.

### BACKGROUND

Recent years have witnessed emergence of rechargeable batteries, also referred to as secondary batteries, as prime power supply units for powering a variety of devices in day-to-day life, such as home appliances, power tools, computers, televisions with satellite dish systems, vehicle batteries, and the like. In addition to having higher capacity and greater energy densities, such secondary batteries are capable of delivering very high currents. The most common secondary batteries in the market today are lithium-ion (Li-Ion), though nickel-metal hydride (NiMH) and nickel-cadmium (NiCd) batteries were also once very prevalent.

With the increased usage of such devices, there is an increased demand for systems and techniques employing various electric components that can recharge such secondary batteries. Such electric components are usually determined by the amount of control desired over the charging current and/or voltage. For different types of secondary batteries, the charging current, the charging rate, and voltage requirements are different.

Unfortunately, the secondary batteries tend to suffer damage each time they are discharged significantly. For this reason, the life expectancy of the secondary batteries, which are periodically discharged, is significantly decreased. In certain existing systems, such as solar panel powering systems that are designed to power up such secondary batteries in battery banks, the setup employed for the battery recharging are cumbersome, incur high installation costs and are generally non-portable. Further, the amount of time required by such solar panel powering systems to charge secondary batteries in battery banks is relatively high. Other than that, one cannot rely totally on such solar panel powering systems are they are weather dependent and hence a backup source is always required. In other existing systems, such as vehicles, alternators may be employed for recharging the vehicle batteries. However, such alternators may create magnetic field that may be unwanted in case other electrical appliances are being used in vicinity of such systems.

Further limitations and disadvantages of existing, conventional and traditional approaches will become apparent to one of skill in the art, through comparison of such systems with some aspects of the present disclosure as set forth in the remainder of the present application with reference to the drawings.

### BRIEF SUMMARY

System and/or method is provided for battery recharging, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1A depicts a circuit diagram 100A of a battery recharging system 102A and its components, in accordance with an embodiment of the present disclosure;

FIG. 1B depicts another circuit diagram 100B of another battery recharging system 102B and its components, in accordance with another embodiment of the present disclosure;

FIG. 2A depicts a circuit diagram of a powering system 200A and its components, in accordance with an embodiment of the present disclosure;

FIG. 2B depicts another circuit diagram of powering system 200B and its components, in accordance with another embodiment of the present disclosure;

FIG. 3 depicts a flowchart 300 illustrating exemplary operations for battery recharging, in accordance with various exemplary embodiments of the disclosure;

FIG. 4A depicts a first exemplary scenario 400A for battery recharging, in accordance with an embodiment of the disclosure; and

FIG. 4B depicts a second exemplary scenario 400B for battery recharging, in accordance with another embodiment of the disclosure.

### DETAILED DESCRIPTION OF THE EMBODIMENTS

The invention now will be described more fully hereinafter with reference to the accompanying drawings, in which embodiments of the invention are shown. This invention may however be embodied in many different forms and should not be construed as limited to the embodiments set forth herein. Rather, these embodiments are provided so that this disclosure will be thorough and complete, and will fully convey the scope of the invention to those skilled in the art.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. It will be understood that the elements, components, regions, layers and sections depicted in the figures are not necessarily drawn to scale.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. The numbers, ratios, percentages, and other values may include those that are ±5%, ±10%, ±25%, ±50%, ±75%, ±100%, ±200%, ±500%, or other ranges that do not detract from the spirit of the invention. The terms about, approximately, or substantially may include values known to those having ordinary skill in the art. If not known in the art, these terms may be considered to be in the range of up to ±5%, ±10%, or other value higher than these ranges commonly accepted by those having ordinary skill in the art for the variable disclosed. Thus, embodiments of the present invention should not be construed as limited to the particular shapes of regions illustrated herein but are to include deviations in shapes that result, for example, from manufacturing. The invention illustratively disclosed herein suitably may be practiced in the absence of any elements that are not specifically disclosed herein.

Certain embodiments of the disclosure may be found in a system and method for battery recharging. In view of the limitations and disadvantages of the existing, conventional and traditional approaches, it is therefore desirable to provide an efficient and improved system and method for recharging the batteries which overcomes the issues of prior technologies and provides continuous current to a load while at the same time preserving the life of the secondary batteries used.

In accordance with an aspect of the disclosure, a battery recharging system is disclosed. The battery recharging system may include a first battery having a first positive terminal and a first negative terminal. The battery recharging system may further include a second battery having a second positive terminal and a second negative terminal. The battery recharging system may further include a switch configured to be activated in one of a first configuration or a second configuration and connected to the first positive terminal of the first battery, the second positive terminal of the second battery, and the plurality of power devices. In various embodiments, the switch may be activated in one of the first configuration or the second configuration based on a charging level of at least one of the first battery and the second battery. The battery recharging system may further include an inverter from the plurality of power devices. The inverter may include an inverter input terminal, an inverter ground terminal, and an inverter output terminal. The inverter input terminal may be connected to one of the first positive terminal of the first battery or the second positive terminal of the second battery via the switch. The battery recharging system may further include the charger unit from the plurality of power devices. The charger unit may include a charger input terminal, a charger ground terminal, and a charger output terminal. The charger input terminal may be connected to the inverter output terminal of the inverter. The charger output terminal may be connected to one of the first positive terminal of the first battery or the second positive terminal of the second battery via the switch. The battery recharging system may further include the output port connected to the charger output terminal.

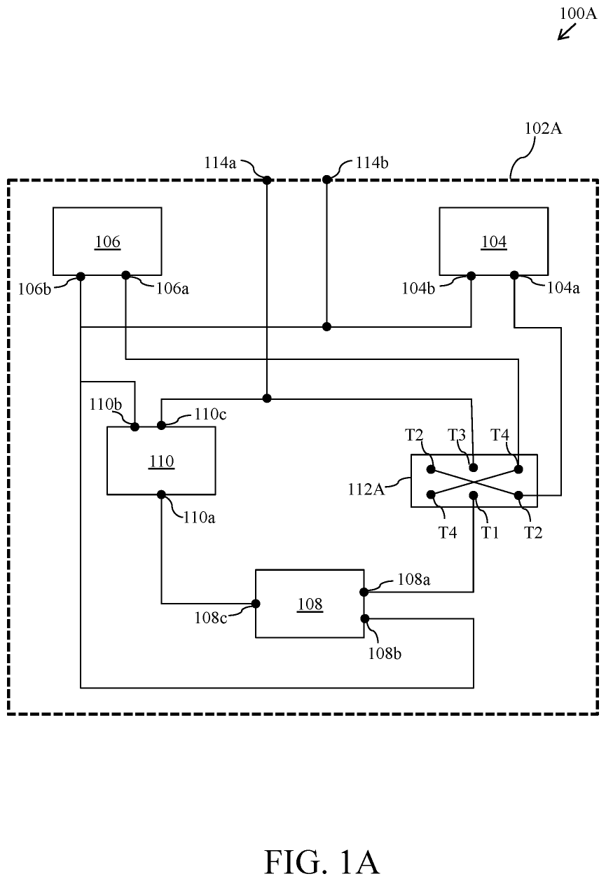

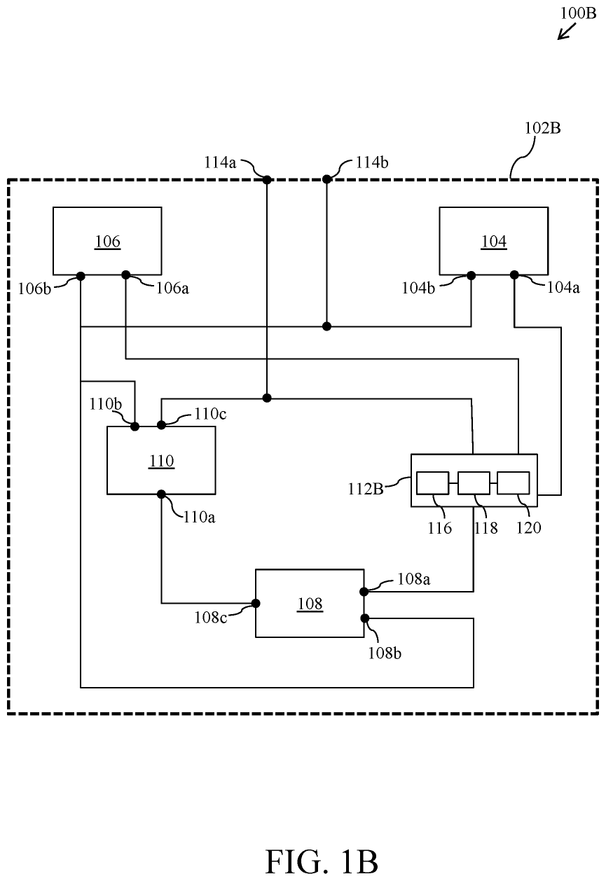

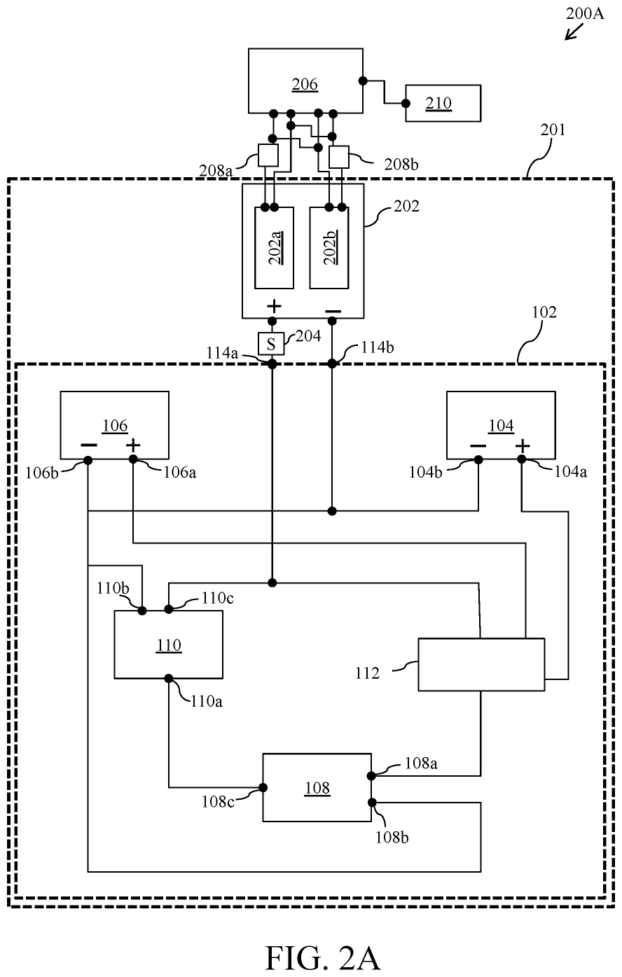

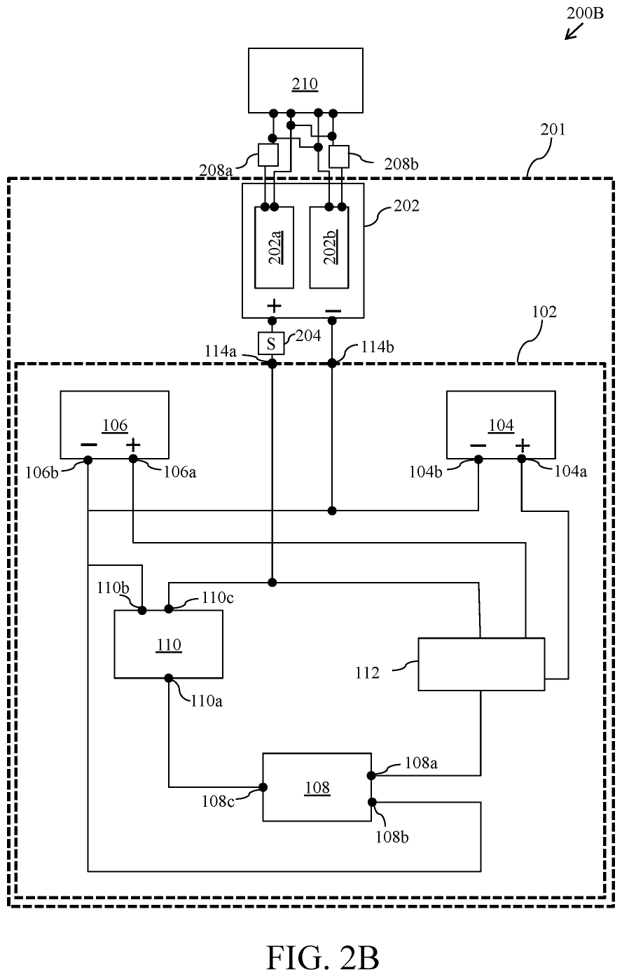

Turning to figures, FIG. 1A depicts a circuit diagram 100A of a battery recharging system 102A and its components, in accordance with an embodiment of the present disclosure. FIG. 1B depicts another circuit diagram 100B of another battery recharging system 102B and its components, in accordance with another embodiment of the present disclosure. FIG. 2A depicts a circuit diagram of a powering system 200A and its components, in accordance with an embodiment of the present disclosure. FIG. 2B depicts another circuit diagram of powering system 200B and its components, in accordance with another embodiment of the present disclosure.

As depicted in FIG. 1A, the battery recharging system 102A includes a plurality of energy storage devices, such as at least a first battery 104 and a second battery 106, and a plurality of power devices, such as an inverter 108 and a charger unit 110, and a pair of output ports, such as an output port 114a and another output port 114b. The battery recharging system 102A further includes a first switch 112A connected to the first battery 104, the second battery 106, the inverter 108, the charger unit 110, and the output port 114a. As depicted in FIG. 1B, all the components and the connections of the battery recharging system 102B may be similar to the components and connections of the battery recharging system 102A, except for a second switch 112B.

For brevity and common description, the battery recharging system 102A (as depicted in FIG. 1A) and the battery recharging system 102B (as depicted in FIG. 1B) may be hereinafter collectively referred to as a battery recharging system 102 (as depicted in FIG. 2A), unless otherwise stated. Similarly, the first switch 112A (as depicted in FIG. 1A) and the second switch 112B (as depicted in FIG. 1B) may be hereinafter collectively referred to as switch 112 (as depicted in FIG. 2A), unless otherwise stated.

The battery recharging system 102 may be configured to convert 12V DC current (from the plurality of energy storage devices) to 120V AC current and then back to 12V DC current and repeats such conversion over and over with the correct Amps being drawn at the pair of output ports, such as the output port 114a and the other output port 114b. The battery recharging system 102 may last as long as the cycle life of the lead acid battery, which may be about 3 to 4 yrs at 500-600 cycles (charging and discharging at 30%). Multiple Amps, i.e. a battery bank, may be hookup with the pair of output ports, such as the output port 114a and the other output port 114b, of the battery recharging system 102 to receive a continuous supply of 12V DC current.

In an exemplary embodiment, the battery recharging system 102 may be configured to perform the same functionality as a solar panel system, however with more compact, portable, and easily manageable setup of electrical devices. In an exemplary scenario, the battery recharging system 102 may be configured to charge a 30% depleted energy storage device, such as a 12V 3,840 Amps battery bank, in limited charging time, such as 3 hours, based on the specification of the electrical devices used in the battery recharging system 102. However, the above instance should not be construed to be limiting and the charging time may vary with respect to the specification of the battery bank, without any deviation from the scope of the disclosure.

Broadly, the two energy storage devices, the plurality of power devices, and the switch 112 in the battery recharging system 102 may be configured in such a manner that power is drawn from a first energy storage device to fully charge up a second energy storage device before the first energy storage device gets depleted below 30% of its charging level. The detailed description is further provided hereinunder.

The plurality of energy storage devices, such as the first battery 104 and the second battery 106, further referred to as storage batteries, secondary batteries, or charge accumulators, may include a cell or a combination of cells in which cell reactions are reversible. This implies that the original chemical conditions within the cell in the first battery 104 may be restored by passing current to flow into it, that is, by charging from an external source, such as the second battery 106. Similarly, the original chemical conditions within the cell in the second battery 106 may be restored by passing current to flow into it, that is, by charging from an external source, such as the first battery 104. Each of the plurality of energy storage devices may cycle itself for charging (100%) and discharging (30%) for specific number of times for specific duration based on the type of manufacturer. For example, in some cases, an energy storage device may do such cycling for 600 times, i.e. for 3 years, whereas in other cases, another energy storage device may do such cycling for 14000 times, i.e. for 10 years.

Each cell may be identical to each other in their configuration. The first battery 104 may include a first positive terminal 104a and a first negative terminal 104b. Similarly, the second battery 106 may include a second positive terminal 106a and a second negative terminal 106b. Examples of the first battery 104 and the second battery 106 may include, for example, a lead acid battery, a nickel based battery, or other such batteries. At a given point in time, one of the first positive terminal 104a of the first battery 104 and the second positive terminal 106a of the second battery 106 may transmit a first input DC signal, S1_{DC}, and a second input DC signal, S2_{DC}, respectively, to the inverter 108 via the switch 112. The first negative terminal 104b of the first battery 104 and the second negative terminal 106b of the second battery 106 respectively may be grounded.

In accordance with an exemplary specification, each of the first battery 104 and the second battery 106 may be a 12V DC 200 Ah Class C20 at 1000 mca battery. Further, each of the first battery 104 and the second battery 106 may be a Group 31M, Absorbent Glass Mat (AGM), Deep-cycle, Dual purpose and flooded battery. According to the exemplary specification, each of the first battery 104 and the second battery 106, which is a 12V DC 200 Ah battery having a battery charging and discharging rate per hour (further referred to as “C” rate of current), such as C20, may guarantee to provide a continuous current of 10 Amps over the discharge period of 20 hours (10 Amps×20 h=200 Ah). However, it should be noted that the above exemplary specification should not be construed to be limiting, and other exemplary specifications of Ah capacity and battery rating, i.e. C rate, may be selected based on a desired output, without any deviation from the scope of the disclosure.

The inverter 108, further referred to as a power inverter, is a power electronic device or circuitry that may be configured to change direct current (DC) signal to alternating current (AC) signal. The resulting AC frequency obtained depends on the particular device employed. The inverter 108 does not produce any power; the power is provided by a DC source, i.e. the plurality of energy storage devices, such as the first battery 104 and the second battery 106.

In accordance with an embodiment, the inverter 108 includes an inverter input terminal 108a, an inverter ground terminal 108b and an inverter output terminal 108c. The inverter input terminal 108a may be connected to one of the first positive terminal 104a of the first battery 104 or the second positive terminal 106a of the second battery 106 via the switch 112. For example, the inverter input terminal 108a is connected to the first positive terminal 104a of the first battery 104 when the switch 112 is active in the first configuration. Accordingly, the inverter 108 may be configured to receive the first input DC signal, S1_{DC}, at the first inverter input terminal 108a, from the first battery 104 when the switch 112 is active in the first configuration. Similarly, the inverter input terminal 108a is connected to the second positive terminal 106a of the second battery 106 when the switch 112 is active in the second configuration. Accordingly, the inverter 108 may be configured to receive the second input DC signal, S2_{DC}, at the first inverter input terminal 108a, from the second battery 106 when the switch 112 is active in the second configuration. Based on one of the first input DC signal, S1_{Dc}, received from the first battery 104 or the second input DC signal, S2_{DC}, received from the second battery 106 via the switch 112, the inverter 108 may be configured to generate an inverter output AC signal. The generated inverter output AC signal may be supplied to the charger unit 110.

In accordance with an exemplary specification, the inverter 108 may be 12V DC at 0-10 Amps (draw) input, 115-124V AC, at 0-150 W inverter output. Specifically, in accordance with an embodiment, the inverter 108 may draw only 10 Amps of current and generate the inverter output AC signal of 120 W. However, it should be noted that the above exemplary specification should not be construed to be limiting, and other exemplary specifications of output power rating of the inverter 108 may be selected based on a desired output and the Ah capacity and battery rating, i.e. C rate, of each of the plurality of energy storage devices, without any deviation from the scope of the disclosure.

The charger unit 110, further referred to as a battery charger or a recharger, is a device that stores energy in the plurality of energy storage devices and additional energy storage devices by running an electric current through them. The charger unit 110 may be configured to generate a charger output DC signal based on the inverter output AC signal generated by the inverter 108. Using the charger output DC signal, the charger unit 110 may charge at least one of the first battery 104 or the second battery 106 in an event when the charging level of the at least one of the first battery 104 and the second battery 106 depletes to 30% of a total charging level. In accordance with an embodiment, the charger unit 110 may further charge an additional energy storage device, such as a third battery 202 (as depicted in FIG. 2A) along with one of the first battery 104 or the second battery 106.

The charging protocol, i.e. how much voltage or current for how long, and what to do when charging is complete, may depend on the size and type of the plurality of energy storage devices and additional energy storage devices being charged. Some energy storage devices may have high tolerance for continued charging after they are fully charged (i.e. overcharged) and may be recharged by connection to a constant voltage source or a constant current source, depending on battery type. In such cases, charger units must be manually disconnected at the end of the charge cycle. Other energy storage devices may use a timer to cut off when charging is complete as such energy storage devices cannot withstand over-charging, and may get damaged (reduced capacity, reduced lifetime), over heated or may even explode. In accordance with an embodiment, the charger unit 110 may have temperature or voltage sensing circuits and a microprocessor controller to safely adjust the charging current and voltage, determine the state of charge, cut off at the end of charge, or beep when the energy storage device is fully charged.

In accordance with an embodiment, the charger unit 110 includes a charger input terminal 110a, a charger ground terminal 110b and a charger output terminal 110c. The charger input terminal 110a is connected to the inverter output terminal 108c of the inverter 108. The charger output terminal 110c is connected to one of the first positive terminal 104a of the first battery 104 or the second positive terminal 106a of the second battery 106 via the switch 112. The charger output terminal 110c is further connected to the output port 114a. In accordance with an embodiment, the charger output terminal 110c is further connected to the third battery 202 (as depicted in FIG. 2A) via the output port 114a.

In accordance with an exemplary specification, the charger unit 110 may be 12V DC at 3-15 Amps output, 115-124V AC input. Specifically, in accordance with an embodiment, the current ampere of the charger unit 110 may be 3 Amps. However, it should be noted that the above exemplary specification should not be construed to be limiting, and other exemplary specifications of the charger unit 110 may be set based on the charging level of one of the first battery 104 or the second battery 106, without any deviation from the scope of the disclosure.

The switch 112 may be a type of switch used to control the flow of current in the battery recharging system 102. In accordance with an embodiment, as shown in FIG. 1A, the switch 112 may correspond to the first switch 112A which may be a Double Pole Double Throw (DPDT) 6-pin knife switch with a current rating of 15 Amps. In such embodiment, the first switch 112A may be operated manually for activation in one of the first configuration or the second configuration.

In another embodiment, as shown in FIG. 1B, the switch 112 may correspond to the second switch 112B in the battery recharging system 102B which may be an automatic switching unit. In such embodiment, the second switch 112B may be operated automatically for activation based on sensing circuits 116, a microprocessor controller 118, and a toggle unit 120, communicatively connected to each other and the plurality of energy storage devices. The sensing circuits 116 may be configured to periodically sense temperature and/or voltage of each of the plurality of energy storage devices, such as the first battery 104 and the second battery 106. Based on inputs from the sensing circuits 116, the microprocessor controller 118 may determine the charging level of each of the plurality of energy storage devices. As soon as the microprocessor controller 118, in conjunction with the sensing circuits 116, determines that one of the plurality of energy storage devices is depleting below 30% of the total charging level, the microprocessor controller 118 may activate the toggle unit 120 in one of the first configuration or the second configuration. Accordingly, the energy storage device that is depleting below 30%, may start getting charged based on the power drawn from other energy storage device.

In accordance with an embodiment, as shown in FIG. 1A, the first switch 112A may include a six terminals corresponding to the six pins. For exemplary purposes, the bottom middle terminal may be referred to as a first terminal T1 that may correspond to the first output terminal of the first switch 112A that powers the inverter 108. The top middle terminal may be referred to as a third terminal T3 that may correspond to the second output terminal of the first switch 112A that powers one of the first battery 104 or the second battery 106 at a given point in time via the charger unit 110. The top left terminal and bottom right terminal may be wired together and referred to as a second terminal T2. Similarly, the top right terminal and bottom left terminal may be wired together and referred to as a fourth terminal T4. The first terminal T1 of the first switch 112A is connected to the inverter input terminal 108a and the second terminal T2 is connected to the first positive terminal 104a of the first battery 104. Further, the third terminal T3 is connected to both of the output port 114a and the charger output terminal 110c, and the fourth terminal T4 of the first switch 112A is connected to the second positive terminal 106a of the second battery 106.

In accordance with the first configuration, the handle of the first switch 112A may be adjusted towards one side such that the third terminal T3 is connected to the fourth terminal T4, and the first terminal T1 is connected to the second terminal T2. In the first configuration, the inverter input terminal 108a draws power from the first positive terminal 104a of the first battery 104 (via the first terminal T1 and the second terminal T2) and the charger unit 110 charges the second battery 106 and the output port 114a (via the third terminal T3 and the fourth terminal T4).

In accordance with the second configuration, the handle of the first switch 112A may be adjusted towards the opposite side such that the third terminal T3 is connected to the second terminal T2, and the first terminal T1 is connected to the fourth terminal T4. In the second configuration, the inverter input terminal 108a draws power from the second positive terminal 106a of the second battery 106 (via the first terminal T1 and the fourth terminal T4) and the charger unit 110 charges the first battery 104 and the output port 114a (via the third terminal T3 and the second terminal T2).

It may be noted that the first negative terminal 104b of the first battery 104, the second negative terminal 106b of the second battery 106, the inverter ground terminal 108b, the charger ground terminal 110b, and the output port 114b is connected to a common ground GND.

The pair of output ports, such as the output port 114a and the other output port 114b, may be provided with continuous power supply of 12V DC by the charger unit 110. In accordance with an embodiment, the pair of output ports, such as the output port 114a and the other output port 114b, may be hooked up with the charger output terminal 110c based on + to + and − to − terminal connections. In accordance with another embodiment, the pair of output ports, such as the output port 114a and the other output port 114b, may be connected to an additional energy storage device, i.e. the third battery 202, as described in FIG. 2A.

In operation, the first switch 112A or the second switch 112B may be activated in a first configuration based on a depletion of the charging level of the second battery 106 nearing 30%. The charger unit 110 may be set at 3 Amps and the inverter 108 starts receiving a first input DC input signal from the first positive terminal 104a of the first battery 104. Based on the received first input DC input signal, the inverter 108 may generate an inverter output AC signal and supply to the charger unit 110. The charger unit 110 may start charging the second battery 106 using the charger output DC signal generated by the charger unit 110 based on the inverter output AC signal received from the inverter 108. Continuous power supply of 12V DC may also be provided at the output port 114a by the charger unit 110.

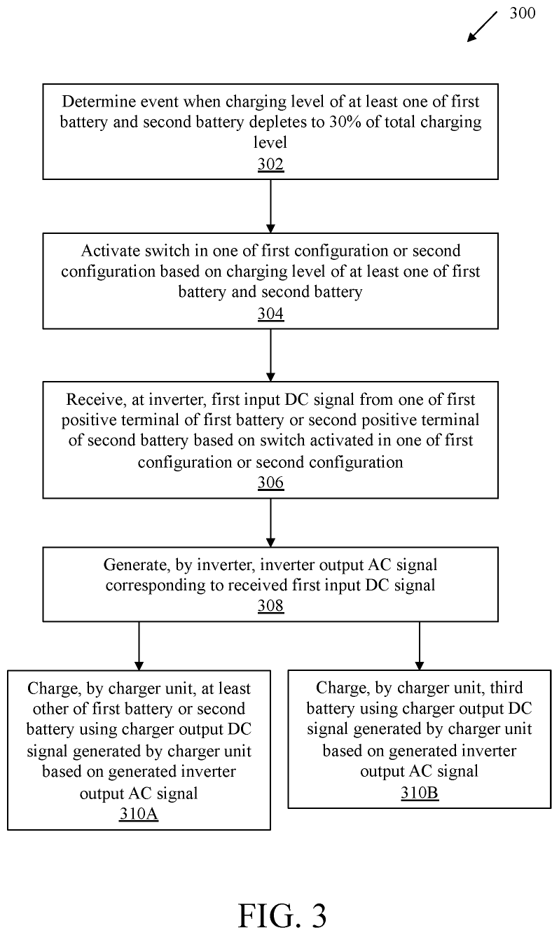

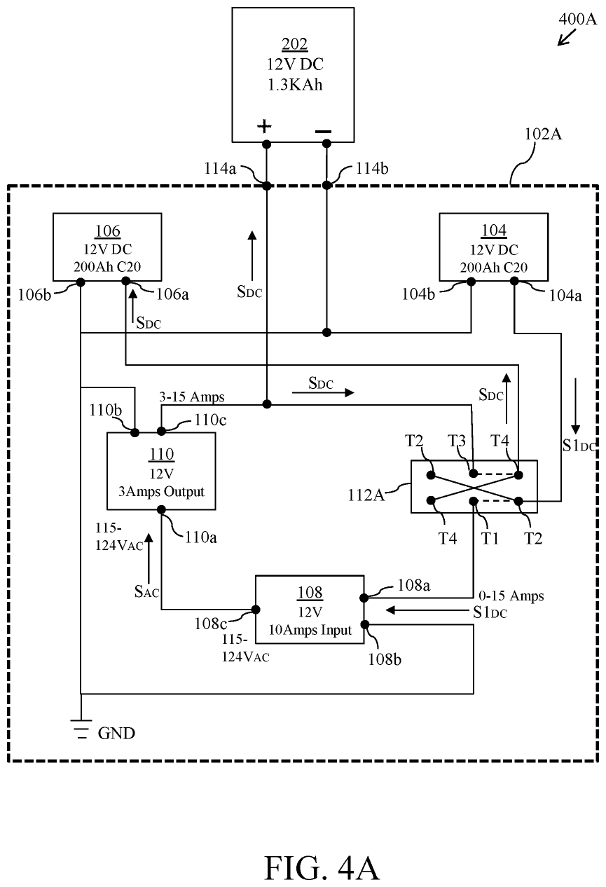

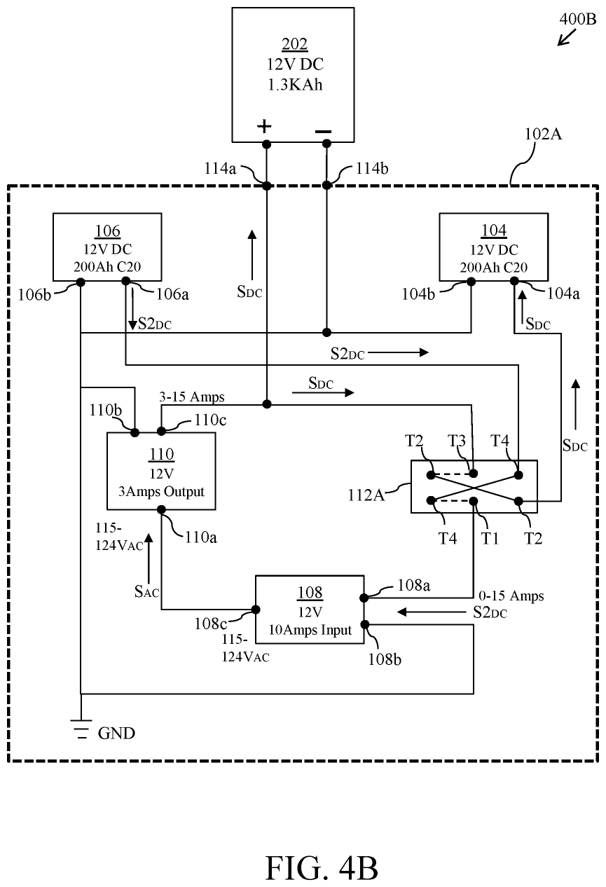

Alternatively, the first switch 112A or the second switch 112B may be activated in a second configuration based on a depletion of the charging level of the first battery 104 nearing 30%. The charger unit 110 may be set at 3 Amps and the inverter 108 starts receiving a second input DC input signal from the second positive terminal 106a of the second battery 106. Based on the received second input DC input signal, the inverter 108 may generate an inverter output AC signal and supply to the charger unit 110. The charger unit 110 may start charging the first battery 104 using the charger output DC signal generated by the charger unit 110 based on the inverter output AC signal received from the inverter 108. Continuous power supply of 12V DC may also be provided at the output port 114a by the charger unit 110. Clearly, whether the first switch 112A or the second switch 112B is activated in the first configuration or the second configuration, power supply of 12V DC is continuously provided at the output port 114a by the charger unit 110 in addition to charging one of the first battery 104 and the second battery 106 having the charging level depleting to 30% of the total charging level. Further description, connection details and signal flow is explained in detail in FIGS. 4A and 4B described in conjunction with FIG. 3.

FIG. 2A depicts a circuit diagram of a powering system 200A and its components, in accordance with an embodiment of the present disclosure. FIG. 2B depicts another circuit diagram of powering system 200B and its components, in accordance with another embodiment of the present disclosure.

The powering system 200A may comprise a DC power supply unit 201. The DC power supply unit 201, comprising the battery recharging system 102 and the third battery 202, may be configured to generate and supply an external DC signal. All the components and connections in the battery recharging system 102 may be similar to the components and connections of the battery recharging system 102A (described in detail in FIG. 1A above), except for the switch 112. The switch 112 in FIG. 2A is a collective (or generalized) representation of the first switch 112A (as depicted in FIG. 1A) and the second switch 112B (as depicted in FIG. 1B).

The powering system 200A may further include the third battery 202. The third battery 202 may include a plurality of battery banks, such as a first battery bank 202a and a second battery bank 202b, connected to the pair of output ports, such as the output port 114a and the other output port 114b, via a selection switch 204. The powering system 200A may further include a main inverter 206 connected to the third battery 202 via a set of cut-off switches, such as cut-off switches 208a and 208b. The powering system 200A may further include one or more external units 210 connected to the main inverter 206.

The third battery 202, further referred to as a set of battery banks or battery packs, may be an additional energy storage device that may include a cell or a combination of cells in which cell reactions are reversible. This implies that the original chemical conditions within the cell in the third battery 202 may be restored by passing current to flow into it, that is, by charging from an external source, such as the first battery 104 or the second battery 106, via the charger unit 110. At a given point in time, the selection for charging one of the first battery bank 202a or the second battery bank 202b of the third battery 202 may be controlled by the selection switch 204.

In accordance with an exemplary specification, the third battery 202 may include four 12V 960 cca dual purpose batteries. Thus, the third battery 202 results in a 3840 cca (960 cca*4) battery that may generate 60 hp (46,080 watts/747 watts), 46,080 watts (3840 cca×12 volts) at 12 v for an exemplary prototype. However, it should be noted that the above exemplary specification should not be construed to be limiting, and other exemplary specifications of power generation of the third battery 202 may be possible based on the specifications of the various components in the battery recharging system 102, without any deviation from the scope of the disclosure.

The main inverter 206, further referred to as a power inverter, is a power electronic device or circuitry that may be configured to convert DC signal to AC signal. Thus, the main inverter 206 may generate a main AC signal based on the external DC signal supplied by the DC power supply unit 201. The main AC signal generated by the main inverter 206 may provide main power to the one or more external units 210 that correspond to AC powered devices. The resulting AC frequency obtained depends on the particular device employed. The main inverter 206 does not produce any power; the power is provided by a DC source, such as the third battery 202 in the DC power supply unit 201. At a given point in time, the selection for receiving power from one of the first battery bank 202a or the second battery bank 202b may be controlled by the alternately activated cut-off switches 208a and 208b. In an exemplary embodiment, the main inverter 206 may be a 7 kW inverter with 12Vin and 120Vout required as house current.

The one or more external units 210 may correspond to both AC and DC powered devices. Examples of the one or more external units 210 may include, but are not limited to, a power supply unit for indoor lighting/appliances, outdoor lighting/appliances, charging an electronic vehicle (EV), lighting of a billboard, powering power tools, all types of consumer electronics and home appliances, recreational vehicles, emergency power, golf karts, and quick setup mobile/stationary security systems. It should be noted that the above examples of the one or more external units 210 should not be construed to be limiting, and more similar instances of the one or more external units 210 may be possible, without any deviation from the scope of the disclosure.

In certain embodiments, as depicted in FIG. 2A, the one or more external units 210 that are AC powered devices, such as home appliances, may be connected to the main inverter 206 for receiving AC signals. In certain embodiments, as depicted in FIG. 2B, the one or more external units 210 that are DC powered devices, such as vehicle batteries, may be connected to the third battery 202 for receiving DC signals. In yet other embodiments, not shown, the one or more external units 210 that correspond to both AC and DC powered devices, may be connected to the main inverter 206 and the third battery 202 for receiving AC and DC signals, respectively.

FIG. 3 depicts a flowchart 300 illustrating exemplary operations for battery recharging, in accordance with various exemplary embodiments of the disclosure. FIG. 3 is described in conjunction with FIGS. 1A, 1B, 2A, 2B, 4A and 4B, in accordance with various exemplary embodiments of the disclosure. FIG. 4A depicts a first exemplary scenario 400A for battery recharging, in accordance with an embodiment of the disclosure. FIG. 4B depicts a second exemplary scenario 400B for battery recharging, in accordance with another embodiment of the disclosure. It should be noted that for understanding purposes, the first exemplary scenario 400A and the second exemplary scenario 400B are based on the circuit diagram 100A of the battery recharging system 102A.

For the two exemplary scenarios 400A and 400B depicted in FIGS. 4A and 4B respectively, it may be assumed that the first battery 104 and the second battery 106 may be 12V DC 200 Ah C20 AGM batteries. The third battery 202 may be a battery bank and include four 12V 960 cca dual purpose batteries. The inverter 108 may be a 12V DC at 10 Amps input, and 115-124V AC at 0-150 W inverter output device. In accordance with the exemplary scenarios, the inverter 108 may draw a maximum of 10 Amps. The charger unit 110 may be 12V DC at 3-15 Amps output, 115-124V AC input. In accordance with the exemplary scenarios, the charger unit 110 may be set to 3 Amps AGM.

It should be noted that for the two exemplary scenarios depicted in FIGS. 4A and 4B, above exemplary specifications of the components are assumed to provide an efficient battery recharging system 102A. However, such exemplary specifications should not be construed to be limiting the scope of the disclosure. The components of the battery recharging system 102A may vary in sizes, materials, shapes, voltages, Amps, Amp hours, C rate values, solid states, or forms (such as mechanical, digital, or analogue). Other higher exemplary specifications may also be possible without any deviation from the scope of the disclosure.

At step 302, an event may be determined when charging level of at least one of the first battery 104 and the second battery 106 depletes to 30% of a total charging level. The charging level may correspond to a percentage of battery charged at a given point in time.

In accordance with an embodiment, the event may be determined manually by a user operating the battery recharging system 102A via a display screen of the charger unit 110. At a given point in time, the display screen of the charger unit 110 may display the current charging level of the first battery 104 or the second battery 106. For example, a value of “80” displayed at the display screen of the charger unit 110 may indicate that a connected battery is 80% charged. In accordance with an embodiment, when the third battery 202 is also being charged along with one of the first battery 104 or the second battery 106, the display screen of the charger unit 110 may display the higher value of the two charging levels.

In accordance with another embodiment, the event may be determined automatically by the microprocessor controller 118 based on inputs received from the sensing circuits 116 at the second switch 112B in the battery recharging system 102B. In certain embodiments, the microprocessor controller 118 may be further configured to generate an audio notification, such as a beep, via an inbuilt speaker.

At step 304, the switch 112, such as the first switch 112A or the second switch 112B, may be activated in one of a first configuration or a second configuration based on a charging level of at least one of the first battery 104 and the second battery 106.

In accordance with an embodiment, the first switch 112A may be manually activated in one of the first configuration or the second configuration based on the charging level of at least one of the first battery 104 and the second battery 106. In the first exemplary scenario 400A, as depicted in FIG. 4A, an event is determined when the second battery 106 is depleting to 30% of the total charging level. Accordingly, handle of the first switch 112A, which may be a knife switch, may be adjusted towards the right side such that the third terminal T3 is connected to the fourth terminal T4, and the first terminal T1 is connected to the second terminal T2 of the first switch 112A, as shown by dotted lines in FIG. 4A. This may correspond to the first configuration of the first switch 112A.

In a second exemplary scenario 400B, as depicted in FIG. 4B, an event is determined when the first battery 104 is depleting to 30% of the total charging level. Accordingly, the handle of the first switch 112A, which may be a knife switch, may be adjusted towards the left side such that the third terminal T3 is connected to the second terminal T2, and the first terminal T1 is connected to the fourth terminal T4 of the first switch 112A, as shown by dotted lines in FIG. 4B. This may correspond to the second configuration of the first switch 112A.

In accordance with another embodiment, the second switch 112B may be automatically activated in one of the first configuration or the second configuration based on the charging level of at least one of the first battery 104 and the second battery 106. In such embodiment, the toggle unit 120, based on an instruction received from the microprocessor controller 118, may activate the second switch 112B in one of the first configuration or the second configuration based on the same connections described above for the first switch 112A.

At step 306, a first input DC signal may be received at the inverter 108 from one of the first positive terminal 104a of the first battery 104 or the second positive terminal 104a of the second battery 106 based on the switch 112 (i.e. the first switch 112A or the second switch 112B) activated in one of the first configuration or the second configuration.

In the first exemplary scenario 400A, as depicted in FIG. 4A, the inverter 108 may receive the first input DC signal, S1_{DC}, and draw only 10 Amps from the first positive terminal 104a of the first battery 104 based on the activation of the first switch 112A in the first configuration. Thus, in the first configuration, the inverter input terminal 108a draws power from the first positive terminal 104a of the first battery 104 (via the first terminal T1 and the second terminal T2). As the first battery 104 is a 200 Ah C20 battery, a continuous current corresponding to the first input DC signal, S1_{DC}, may be provided to the charger unit 110 for 10 hours (200 Ah/20 A) to charge the second battery 106 and the third battery 202.

In the second exemplary scenario 400B, as depicted in FIG. 4B, the inverter 108 may receive the second input DC signal, S2_{DC}, and draw only 10 Amps from the second positive terminal 106a of the second battery 106 based on the activation of the first switch 112A in the second configuration. Thus, in the second configuration, the inverter input terminal 108a draws power from the second positive terminal 106a of the second battery 106 (via the first terminal T1 and the fourth terminal T4). As the second battery 106 is a 200 Ah C20 battery, a continuous current corresponding to the second input DC signal, S2_{DC}, may be provided to the charger unit 110 for 10 hours (200 Ah/20 A) to charge the first battery 104 and the third battery 202.

At step 308, the inverter 108 may generate an inverter output AC signal corresponding to the received first input DC signal. The maximum current that the inverter 108 can draw may be 10 Amps.

In the first exemplary scenario 400A, as depicted in FIG. 4A, the inverter 108 may generate the inverter output AC signal, SAC, corresponding to the first input DC signal, S1_{DC}, received from the first positive terminal 104a of the first battery 104 based on the activation of the first switch 112A in the first configuration.

In the second exemplary scenario 400B, as depicted in FIG. 4B, the inverter 108 may generate the inverter output AC signal, SAC, corresponding to the second input DC signal, S2_{DC}, received from the second positive terminal 106a of the second battery 106 based on the activation of the first switch 112A in the second configuration.

At step 310A, at least other of the first battery 104 or the second battery 106 may be charged by the charger unit 110 using a charger output DC signal, S_{DC}, generated by the charger unit 110 based on the generated inverter output AC signal, SAC.

In the first exemplary scenario 400A, as depicted in FIG. 4A, the charger unit 110 may receive the inverter output AC signal, SAC, generated by the inverter 108 corresponding to the first input DC signal, S1_{DC}, received from the first positive terminal 104a of the first battery 104. Based on the inverter output AC signal, SAC, the charger unit 110 may generate a charger output DC signal, S_{DC}, and charge the second battery 106 using the charger output DC signal, S_{DC}. The charger unit 110 may charge the second battery 106 via the third terminal T3 and the fourth terminal T4 of the first switch 112A. As the charger unit 110 is set at 3 Amps, the charger unit 110 may charge the second battery 106 and the third battery 202 in only 3 hours and utilize the remaining hours (i.e. 7 hours left with the first battery 104 without recharging) in the next charging cycle of the second battery 106.

In the second exemplary scenario 400B, as depicted in FIG. 4B, the charger unit 110 may receive the inverter output AC signal, SAC, generated by the inverter 108 corresponding to the second input DC signal, S2_{DC}, received from the second positive terminal 106a of the second battery 106. Based on the inverter output AC signal, SAC, the charger unit 110 may generate a charger output DC signal, S_{DC}, and charge the first battery 104 using the charger output DC signal, S_{DC}. The charger unit 110 may charge the first battery 104 via the second terminal T2 and the third terminal T3 of the first switch 112A. As the charger unit 110 is set at 3 Amps, the charger unit 110 may charge the first battery 104 and the third battery 202 in only 3 hours and utilize the remaining hours (i.e. 7 hours left with the second battery 106 without recharging) in the next charging cycle of the first battery 104.

In both the scenarios, i.e. when the first switch 112A is in the first configuration or the second configuration, power is drawn from one battery by the inverter 108 and the other battery is charged by the charger unit 110 using the power drawn by the inverter 108 from the former battery. The charger unit 110 may continually keep charging the first battery 104 (when the first switch 112A is in the second configuration) and second battery 106 (when the first switch 112A is in the first configuration) alternately in 3 hours laps, in accordance with the exemplary specification provided above. However, the charging time of 3 hours may vary depending on the variation of the exemplary specification of all the components (in tandem) of the battery recharging system 102.

At step 310B, in parallel to the step 310A, the third battery 202 may be charged by the charger unit 110 using the charger output DC signal, S_{DC}, generated by the charger unit 110 based on the generated inverter output AC signal, SAC.

In the first exemplary scenario 400A, as depicted in FIG. 4A, the third battery 202 may be charged by the charger unit 110 using the charger output DC signal, S_{DC}, generated by the charger unit 110 based on the inverter output AC signal, SAC. Similarly, in the second exemplary scenario 400B, as depicted in FIG. 4B, the third battery 202 may be charged by the charger unit 110 using the charger output DC signal, S_{DC}, generated by the charger unit 110 based on the inverter output AC signal, SAC. Thus, irrespective of the first switch 112A activated in either the first configuration or the second configuration, the third battery 202 is continuously and uninterruptedly charged by the charger unit 110 via the output port 114a. In accordance with the exemplary specification provided above, the third battery 202 results in a 3840 cca (960 cca*4) battery that may generate 60 hp (46,080 watts/747 watts), 46,080 watts (3840 cca×12 volts) at 12 v for an exemplary prototype. However, the power generated by the third battery 202 may vary depending on the variation of the exemplary specification of all the components (in tandem) of the battery recharging system 102.

In accordance with an aspect of the disclosure, the battery recharging systems 102A and 102B, collectively referred to as the battery recharging system 102, are disclosed. The battery recharging system 102 may include the first battery 104 having the first positive terminal 104a and the first negative terminal 104b. The battery recharging system 102 may further include the second battery 106 having the second positive terminal 106a and the second negative terminal 106b. The battery recharging system 102 may further include the switch 112 configured to be activated in one of a first configuration or a second configuration and connected to the first positive terminal 104a of the first battery 104, the second positive terminal 106a of the second battery 106, and the plurality of power devices. In various embodiments, the switch 112 may be activated in one of the first configuration or the second configuration based on a charging level of at least one of the first battery 104 and the second battery 106. The battery recharging system 102 may further include the inverter 108 from the plurality of power devices. The inverter 108 may include the inverter input terminal 108a, the inverter ground terminal 108b, and the inverter output terminal 108c. The inverter input terminal 108a may be connected to one of the first positive terminal 104a of the first battery 104 or the second positive terminal 106a of the second battery 106 via the switch 112. The battery recharging system 102 may further include the charger unit 110 from the plurality of power devices. The charger unit 110 may include the charger input terminal 110a, the charger ground terminal 110b, and the charger output terminal 110c. The charger input terminal 110a may be connected to the inverter output terminal 108c of the inverter 108. The charger output terminal 110c may be connected to one of the first positive terminal 104a of the first battery 104 or the second positive terminal 106a of the second battery 106 via the switch 112. The battery recharging system 102 may further include the output port 114a connected to the charger output terminal 110c.

In accordance with an embodiment, based on one of the first or the second configuration of the switch 112, the charger unit 110 may be configured to charge at least one of the first battery 104 and the second battery 106 in an event when the charging level of the at least one of the first battery 104 and the second battery 106 depletes to 30% of a total charging level.

In accordance with an embodiment, the inverter 108 may be configured to draw power from the first battery 104 when the switch 112 is activated in the first configuration. In accordance with such embodiment, the charger unit 110 may be configured to charge the second battery 106 based on the power drawn from the inverter 108 from the first battery 104.

In accordance with an embodiment, the inverter 108 may be configured to draw power from the second battery 106 when the switch 112 is activated in the second configuration. In accordance with such embodiment, the charger unit 110 may be configured to charge the first battery 104 based on the power drawn from the inverter 108 from the second battery 106.

In accordance with an embodiment, each of the first negative terminal 104b of the first battery 104, the second negative terminal 106b of the second battery 106, the inverter ground terminal 108b, and the charger ground terminal 110b is connected to ground.

In accordance with an embodiment, the output port 114a may be hooked up with the charger output terminal 110c.

In accordance with an embodiment, the output port 114a may be connected to the third battery 202. The third battery 202 may be charged based on a charger output DC signal, S_{DC}, generated by the charger unit 110. The third battery 202 may be continuously charged when the switch 112 is activated in the first configuration or the second configuration. In accordance with an embodiment, the third battery 202 may correspond to a battery bank, such as a first battery bank 202a and a second battery bank 202b, and/or one or more external units 210. The one or more external units 210 may correspond to AC powered devices or DC powered devices.

In accordance with an embodiment, the switch 112 may correspond to one of a manual knife switch, such as the first switch 112A, or an automatic switching unit, such as the second switch 112B.

In accordance with another aspect of the disclosure, a method for battery recharging is disclosed. The method may include activating, manually or automatically by the combination of sensing circuits 116, the microprocessor controller 118, and the toggle unit 120, the switch 112 in one of the first configuration or the second configuration based on the charging level of at least one of the first battery 104 and the second battery 106. The switch 112 may be connected to the first positive terminal 104a of the first battery 104, the second positive terminal 106a of the second battery 106, and the plurality of power devices. The method may further include receiving, at the inverter 108, the first input DC signal, S1_{DC}, from one of the first positive terminal 104a of the first battery 104 or the second positive terminal 106a of the second battery 106 based on the switch 112 activated in one of the first configuration or the second configuration. The method may further include generating, by the inverter 108, the inverter output AC signal, SAC, corresponding to the received first input DC signal, S1_{DC} The method may further include charging, by the charger unit 110, at least other of the first battery 104 or the second battery 106 using the charger output DC signal, S_{DC}, generated by the charger unit 110 based on the generated inverter output AC signal, SAC.

In accordance with an embodiment, the method may further include determining, manually or by the microprocessor controller 118, an event when charging level of at least one of first battery 104 and second battery 106 depletes to 30% of the total charging level.

In accordance with an embodiment, the method may further include charging, by the charger unit 110, the at least one of the first battery 104 and the second battery 106 in the event when the charging level of the at least one of the first battery 104 and second battery 106 depletes to 30% of the total charging level.

In accordance with an embodiment, the method may further include drawing power, by the inverter 108, from the first battery 104 when the switch 112 is activated in the first configuration. The method may further include charging, by the charger unit 110, the second battery 106 based on the power drawn from the inverter 108 from the first battery 104.

In accordance with an embodiment, the method may further include drawing power, by the inverter 108, from the second battery 106 when the switch 112 is activated in the second configuration. The method may further include charging, by the charger unit 110, the first battery 104 based on the power drawn from the inverter 108 from the second battery 106.

In accordance with an embodiment, the output port 114a may be hooked up to with the charger output terminal 110c.

In accordance with an embodiment, the method may further include charging the third battery 202 based on the charger output DC signal, S_{DC}, generated by the charger unit 110. The third battery 202 may be connected to the output port 114a. The third battery 202 may be continuously charged when the switch 112 is activated in the first configuration or the second configuration. The third battery 202 may correspond to a battery bank and/or one or more external units 210. The one or more external units 210 may correspond to AC powered devices or DC powered devices.

In accordance with another aspect of the disclosure, the powering system 200A is disclosed. The powering system 200A may comprise the DC power supply unit 201. The DC power supply unit 201 may comprise the battery recharging system 102 and the third battery 202, configured to generate and supply an external DC signal. The battery recharging system 102 may include the first battery 104 having the first positive terminal 104a and the first negative terminal 104b. The battery recharging system 102 may further include the second battery 106 having the second positive terminal 106a and the second negative terminal 106b. The battery recharging system 102 may further include the switch 112 configured to be activated in one of a first configuration or a second configuration and connected to the first positive terminal 104a of the first battery 104, the second positive terminal 106a of the second battery 106, and the plurality of power devices. In various embodiments, the switch 112 may be activated in one of the first configuration or the second configuration based on a charging level of at least one of the first battery 104 and the second battery 106. based on a charging level of at least one of the first battery 104 and the second battery 106. The battery recharging system 102 may further include the inverter 108 from the plurality of power devices. The inverter 108 may include the inverter input terminal 108a, the inverter ground terminal 108b, and the inverter output terminal 108c. The inverter input terminal 108a may be connected to one of the first positive terminal 104a of the first battery 104 or the second positive terminal 106a of the second battery 106 via the switch 112. The battery recharging system 102 may further include the charger unit 110 from the plurality of power devices. The charger unit 110 may include the charger input terminal 110a, the charger ground terminal 110b, and the charger output terminal 110c. The charger input terminal 110a may be connected to the inverter output terminal 108c of the inverter 108. The charger output terminal 110c may be connected to one of the first positive terminal 104a of the first battery 104 or the second positive terminal 106a of the second battery 106 via the switch 112. The battery recharging system 102 may further include the output port 114a connected to the charger output terminal 110c and the third battery 202. The battery recharging system 102 may further include the main inverter 206, connected to the DC power supply unit 201, configured to generate a main AC signal based on the external DC signal supplied by the DC power supply unit 201. The main AC signal generated by the main inverter 206 may provide main power to one or more external units 210.

In accordance with an embodiment, the third battery 202 may correspond to a battery bank configured to supply the external DC signal to the main inverter 206. The third battery 202 may be continuously charged when the switch 112 is activated in the first configuration or the second configuration.

The proposed battery recharging system 102 provides numerous advantages in light of the prior art. For example, the life expectancy of the secondary batteries, which are periodically discharged, is significantly decreased. The proposed battery recharging system 102 mitigates this problem by not allowing any of the batteries to deplete below 30%, thereby prolonging the battery life. Further, in contrast to other systems, such as solar panel powering systems, that are designed to power up such secondary batteries in battery banks, the setup employed for the proposed battery recharging system is easy to manage, incur lower installation costs and portable. The proposed battery recharging system 102 is weather independent, hence doesn't require any backup source. Furthermore, the amount of time required by the proposed battery recharging system 102 to charge secondary batteries in battery banks is relatively low. Furthermore, in contrast to alternators, the proposed battery recharging system 102 does not create any magnetic field thereby safe to be used with other power devices in vicinity.

As utilized herein the terms “circuits” and “circuitry” refer to physical electronic components (for example, hardware) and any software and/or firmware (“code”) which may configure the hardware, be executed by the hardware, and/or otherwise be associated with the hardware. As used herein, for example, a particular processor and memory may comprise a first “circuit” when executing first one or more lines of code and may comprise a second “circuit” when executing second one or more lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and/or code (if any is necessary) to perform the function, regardless of whether performance of the function is disabled, or not enabled, by some user-configurable setting.

The terminology used herein is for the purpose of describing particular embodiments only and is not intended to be limiting of embodiments of the disclosure. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, those of skill in the art will appreciate that the various illustrative logical blocks, modules, circuits, algorithms, and/or steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

While the present disclosure has been described with reference to certain embodiments, it will be noted understood by, for example, those skilled in the art that various changes and modifications could be made and equivalents may be substituted without departing from the scope of the present disclosure as defined, for example, in the appended claims. In addition, many modifications may be made to adapt a particular situation or material to the teachings of the present disclosure without departing from its scope. The functions, steps and/or actions of the method claims in accordance with the embodiments of the disclosure described herein need not be performed in any particular order. Furthermore, although elements of the disclosure may be described or claimed in the singular, the plural is contemplated unless limitation to the singular is explicitly stated. Therefore, it is intended that the present disclosure not be limited to the particular embodiment disclosed, but that the present disclosure will include all embodiments falling within the scope of the appended claims.

While the invention has been described in terms of exemplary embodiments, it is to be understood that the words that have been used are words of description and not of limitation. As is understood by persons of ordinary skill in the art, a variety of modifications can be made without departing from the scope of the invention defined by the following claims, which should be given their fullest, fair scope.

What is claimed is:

1. A system for battery recharging, comprising:
a first battery having a first positive terminal and a first negative terminal;
a second battery having a second positive terminal and a second negative terminal;
a switch configured to be activated in one of a first configuration or a second configuration and connected to the first positive terminal of the first battery, the second positive terminal of the second battery, and a plurality of power devices,
wherein the switch is activated in one of the first configuration or the second configuration based on a charging level of at least one of the first battery and the second battery;
an inverter from the plurality of power devices, the inverter including an inverter input terminal, an inverter ground terminal and an inverter output terminal,
wherein the inverter input terminal is connected to one of the first positive terminal of the first battery or the second positive terminal of the second battery via the switch;
a charger unit from the plurality of power devices, the charger unit including a charger input terminal, a charger ground terminal, and a charger output terminal,
wherein the charger input terminal is connected to the inverter output terminal of the inverter,
wherein the charger output terminal is connected to one of the first positive terminal of the first battery or the second positive terminal of the second battery via the switch; and,
an output port connected to the charger output terminal.

2. The system according to claim 1, wherein, based on one of the first or the second configuration of the switch, the charger unit is configured to charge at least one of the first battery and the second battery in an event when the charging level of at least one of the first battery and the second battery depletes to 30% of a total charging level.

3. The system according to claim 2, wherein the inverter is configured to draw power from the first battery when the switch is activated in the first configuration.

4. The system according to claim 3, wherein the charger unit is configured to charge the second battery based on the power drawn from the inverter from the first battery.

5. The system according to claim 2, wherein the inverter is configured to draw power from the second battery when the switch is activated in the second configuration.

6. The system according to claim 5, wherein the charger unit is configured to charge the first battery based on the power drawn from the inverter from the second battery.

7. The system according to claim 1, wherein each of the first negative terminal of the first battery, the second negative terminal of the second battery, the inverter ground terminal, and the charger ground terminal is connected to ground.

8. The system according to claim 1, wherein the output port is hooked up with the charger output terminal.

9. The system according to claim 1, wherein the output port is connected to a third battery,
wherein the third battery is charged based on a charger output DC signal generated by the charger unit,
wherein the third battery is continuously charged when the switch is activated in the first configuration or the second configuration.

10. The system according to claim 9, wherein the third battery corresponds to a battery bank and/or one or more external units,
wherein the one or more external units correspond to AC powered devices or DC powered devices.

11. The system according to claim 1, wherein the switch corresponds to one of a manual knife switch or an automatic switching unit.

12. A method for battery recharging, comprising:
activating a switch in one of a first configuration or a second configuration based on a charging level of at least one of a first battery and a second battery,
wherein the switch is connected to a first positive terminal of the first battery, a second positive terminal of the second battery, and a plurality of power devices;
receiving, at an inverter, a first input direct current (DC) signal from one of the first positive terminal of the first battery or the second positive terminal of the second battery based on the switch activated in one of the first configuration or the second configuration;
generating, by the inverter, an inverter output alternating current (AC) signal corresponding to the first input direct current (DC) signal; and,
charging, by a charger unit, at least other of the first battery or the second battery using a charger output DC signal generated by the charger unit based on the inverter output alternating current (AC) signal.

13. The method according to claim 12, wherein the method further comprising determining an event when charging level of at least one of the first battery and the second battery depletes to 30% of total charging level.

14. The method according to claim 13, wherein the method further comprising charging at least one of the first battery and the second battery in the event when the charging level of at least one of the first battery and the second battery depletes to 30% of the total charging level.

15. The method according to claim 14, wherein the method further comprising:
drawing power, by the inverter, from the first battery when the switch is activated in the first configuration; and,
charging, by the charger unit, the second battery based on the power drawn from the inverter from the first battery.

16. The method according to claim 14, wherein the method further comprising:
drawing power, by the inverter, from the second battery when the switch is activated in the second configuration; and,
charging, by the charger unit, the first battery based on the power drawn from the inverter from the second battery.

17. The method according to claim 12, further comprising charging a third battery based on the charger output DC signal generated by the charger unit,
wherein the third battery is connected to an output port,
wherein the third battery is continuously charged when the switch is activated in the first configuration or the second configuration.

18. The method according to claim 17, wherein the third battery corresponds to a battery bank and/or one or more external units,
wherein the one or more external units correspond to AC powered devices or DC powered devices.

19. A powering system, comprising:
a direct-current (DC) power supply unit, comprising a battery recharging system and a third battery, configured to generate and supply an external DC signal,
wherein the battery recharging system comprises:
a first battery having a first positive terminal and a first negative terminal;
a second battery having a second positive terminal and a second negative terminal;
a switch configured to be activated in one of a first configuration or a second configuration and connected to the first positive terminal of the first battery, the second positive terminal of the second battery, and a plurality of power devices,
wherein the switch is activated in one of the first configuration or the second configuration based on a charging level of at least one of the first battery and the second battery;
an inverter from the plurality of power devices, the inverter including an inverter input terminal, an inverter ground terminal and an inverter output terminal,
wherein the inverter input terminal is connected to one of the first positive terminal of the first battery or the second positive terminal of the second battery via the switch;
a charger unit from the plurality of power devices, the charger unit including a charger input terminal, a charger ground terminal, and a charger output terminal,
wherein the charger input terminal is connected to the inverter output terminal of the inverter,
wherein the charger output terminal is connected to one of the first positive terminal of the first battery or the second positive terminal of the second battery via the switch;
an output port connected to the charger output terminal and the third battery; and,
a main inverter, connected to the DC power supply unit, configured to generate a main alternating current (AC) signal based on the external DC signal supplied by the DC power supply unit,
wherein the main AC signal generated by the main inverter provides main power to one or more external units.

20. The powering system according to claim 19, wherein the third battery corresponds to a battery bank configured to supply the external DC signal to the main inverter,
wherein the third battery is continuously charged when the switch is activated in the first configuration or the second configuration.
